(19) United States
(12) Patent Application Publication
(10) Pub. No.: US 2016/0068675 A1
(43) Pub. Date: Mar. 10, 2016

(54) THERMOSETTING MATERIALS WITH IMPROVED FRACTURE TOUGHNESS

(71) Applicant: ARKEMA FRANCE, Colombes (FR)

(72) Inventors: Quentin PINEAU, Evreux (FR); Maho YASUDA, Takamaysu City, Kagawa (JP)

(73) Assignee: ARKEMA FRANCE, Colombes, OT (FR)

(21) Appl. No.: 14/786,058

(22) PCT Filed: Apr. 10, 2014
(86) PCT No.: PCT/FR2014/050864

§ 371 Date: Oct. 21, 2015

(30) Foreign Application Priority Data
Apr. 22, 2013 (FR) 1353633

(51) Int. Cl. C08L 63/00; C08G 59/24; C08G 59/50; C08L 77/06

(52) U.S. Cl. CPC C08L 63/00; C08L 77/06; C08G 59/245; C08G 59/504; C08L 2205/06; C08L 2205/05; C08L 2205/03

(57) ABSTRACT

The present invention relates to a composition including, by weight, the total being 100%: 50 to 99% of a curable resin and of a curing agent in a molar ratio in the range of 1/5 to 5/1, and 1 to 50% of a mixture: of a polyamide which includes at least one monomer resulting from the condensation of a diacid and of a diamine of formula (1) where:

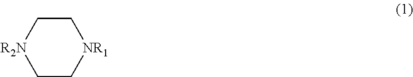

R₁ is H or —Z1-NH2 and Z1 is an alkyl, a cycloalkyl or an aryl having up to 15 carbon atoms, and R₂ is H or —Z2-NH2 and Z2 is an alkyl, a cycloalkyl or an aryl having up to 15 carbon atoms, R₁ and R₂ being either identical or different, and of an oligomer made from butadiene and acrylonitrile which are terminated by carboxyl functions or by amine functions, such as the reactive rubbers CTBN or ATBN; the polyamide and the oligomer being present in respective proportions of 1/10 to 10/1 by weight.

### FIELD OF THE INVENTION

The present invention relates to thermoset materials with improved fracture toughness, and which have good impact strength, rigidity and glass transition temperature (Tg hereinbelow) properties.

Two main definitions of the fracture toughness are generally used: the critical energy restitution value and the critical stress intensity factor.
The critical stress intensity factor, K1C (in MPa/√m), defines for a material the critical stress value beyond which fracture is produced. The stress intensity factor, K1C, is a measure of the applied stress associated with the size of the cracks.
The critical energy restitution value, G1C (in J/m²), is defined as the critical energy required for propagation of a crack per unit area. If a stress exerted on a sample exceeds the critical energy, a fracture is produced.

A thermoset material is defined as being formed from polymer chains of variable length linked together via covalent bonds so as to form a three-dimensional network. Thermoset materials may be obtained, for example, by reaction of a thermosetting resin such as an epoxy with a hardener of amine type. Thermoset materials have many advantageous properties especially for use as structural adhesives or as matrix for composite materials or alternatively in applications for protecting electronic components.

Preferably, the abovementioned applications require thermoset materials that ideally have the following properties:
Tg greater than 170° C. (DMA, ISO6721-5)
Flexural modulus greater than 2 GPa (ISO 178)
Tensile modulus greater than 2 GPa (ISO 527)
Impact strength—notched Charpy impact—greater than 2 KJ/m² (ISO 179-1)
Impact strength—non-notched Charpy impact—greater than 20 KJ/m² (ISO 179-1)
and for the invention it is sought in particular to improve the K1C and G1C (ASTM D5045), preferably to achieve K1C values of greater than 1 MPa/√m, and G1C values of greater than 400 J/m², ensuring excellent fracture toughness of the thermoset materials.

### THE TECHNICAL PROBLEM

Among the thermoset materials, epoxy materials have a high crosslinking density, which gives them a high Tg giving the material excellent thermomechanical properties. The higher the crosslinking density, the higher the Tg of the material and consequently the better the thermomechanical properties: the higher the limit working temperature of the material. For many applications, the fracture toughness or impact strength properties of the current epoxy-based materials are insufficient. While epoxy materials are on the whole difficult to strengthen against impacts, the most difficult are epoxy materials with a high Tg. Numerous studies have been devoted to the impact strengthening of these high-Tg epoxy materials and these studies conclude that the addition of rubber to a high-Tg epoxy material has no strengthening effect. As examples of such materials, mention may be made of the BADGE/DDS systems (Tg=220° C.) in which DDS denotes diaminodiphenyl sulfone or the BADGE/MCDEA systems (Tg=180° C.) in which MCDEA denotes 4,4′-methylenebis(3-chloro-2,6-diethylaniline). In the preceding materials BADGE denotes bisphenol A diglycidyl ether.

For example, the addition of reactive rubbers, such as ATBN or CTBN, to epoxy matrices has been previously tested. These abbreviations mean:

CTBN: Carboxyl terminated random copolymer of butadiene and acrylonitrile.
ATBN: Amino terminated random copolymer of butadiene and acrylonitrile.
These products are oligomers based on butadiene and acrylonitrile terminated either with carboxyl functions or with amine functions. The butadiene has a very low Tg, which is favorable for obtaining good impact strength, but it is miscible with epoxy resins. A certain percentage of acrylonitrile is copolymerized with the butadiene so that the product formed is initially miscible with the epoxy resin and can thus be readily incorporated therein. P. Lovell (Macromol. Symp. 92, Pages 71-81, 1995) and A. Mazouz et al. Polymer Material Science Engineering, 70, p. 17, 1994 relate that following the crosslinking reaction, part of the functional oligomer forms elastomeric particles and an appreciable part remains incorporated in the matrix. This is reflected by a lowering of the Tg of the material obtained relative to the pure epoxy network, which is undesirable for applications requiring good thermomechanical properties. The elastomeric domains formed have a large size conventionally between 0.5 microns and 5 microns. The reinforcement obtained is unsatisfactory.

Patent WO03063572 describes homogeneous compositions comprising a thermosetting (or crosslinkable) resin and a polyamide bearing piperazine units. It is not necessary to add a solvent and the composition before crosslinking is homogeneous, and can thus be readily injected or used for coating surfaces. Furthermore, if the polyamide bearing piperazine units has enough functions to crosslink the thermosetting resin, then it is not necessary to add a hardener. According to said document, said compositions make it possible to obtain a thermoset material with very good impact strength. Furthermore, the usual thermomechanical properties of thermoset materials such as the high Tg and the flexural modulus are said to be conserved.

In practice, even though the thermosetting matrix conserves its rigidity and its impact strength is improved, it is seen that this is not always the case for other properties such as the fracture toughness, and the Tg decreases.

Specifically, the fracture toughness of the thermoset matrix is insufficient, and is not improved by incorporating polyamide into these compositions. Similarly, the Tg in these compositions is greatly reduced (see table 2 of the examples) by incorporating polyamide due to its good miscibility with the thermosetting matrix.

Moreover, EP 0232225 describes compositions comprising an epoxy resin, an acrylic oligomer, an amino compound and a nitrile rubber bearing amine end groups. The fracture toughness (K1C and G1C) is not specified in said document.

The aim of the present invention is thus to provide thermoset compositions with improved fracture toughness, and which in parallel have impact strength, rigidity and Tg properties that satisfy predefined requirements.

The Applicant has now found that the combined use of polyamide and oligomer selected by the invention in a thermoset composition makes it possible to obtain thermoset compositions with markedly improved fracture toughness, while at the same time conserving excellent impact strength, rigidity and Tg properties, which are compatible with use as structural adhesives or as matrix for composite materials or alternatively in applications for protecting electronic components.

### DESCRIPTION OF THE INVENTION

One subject of the present invention is thus a composition comprising by weight, the total being 100%:
10% to 99% of thermosetting resin and of hardener in a mole ratio within the range from 1/5 to 5/1, and
1% to 90% of a mixture:
   of polyamide which comprises at least one monomer resulting from the condensation of a diacid and a diamine of formula (1) below:

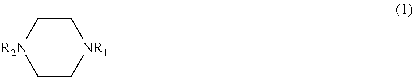

in which:
R₁ represents H or —Z1-NH2 and Z1 represents an alkyl, a cycloalkyl or an aryl containing up to 15 carbon atoms, and
R₂ represents H or —Z2-NH2 and Z2 represents an alkyl, a cycloalkyl or an aryl containing up to 15 carbon atoms,
R₁ and R₂ possibly being identical or different, and
of oligomer based on butadiene and acrylonitrile terminated either with carboxyl functions or with amine functions, such as the reactive rubbers CTBN or ATBN;
polyamide and oligomer being in respective weight proportions of from 1/10 to 10/1.

A subject of the present invention is especially the use of a mixture of polyamide and oligomer in a thermoset matrix for improving its fracture toughness as determined according to standard ASTMD5045,
the thermoset matrix comprising a thermosetting resin and a hardener in a mole ratio included in the range from 1/5 to 5/1,
said polyamide comprising at least one monomer resulting from the condensation of a diacid and a diamine of formula (1) below:

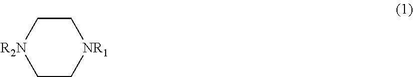

in which:
R₁ represents H or —Z1-NH2 and Z1 represents an alkyl, a cycloalkyl or an aryl containing up to 15 carbon atoms, and
R₂ represents H or —Z2-NH2 and Z2 represents an alkyl, a cycloalkyl or an aryl containing up to 15 carbon atoms,
R₁ and R₂ possibly being identical or different, and
the oligomer being based on butadiene and acrylonitrile terminated either with carboxyl functions or with amine functions, such as the reactive rubbers CTBN or ATBN; and
said mixture representing from 1% to 90% by weight, relative to the total weight of the thermoset matrix, and the polyamide and the oligomer being in respective weight proportions of from 1/10 to 10/1 and preferably from 1/5 to 5/1.

Advantageously, the composition comprises from 50% to 99% by weight of thermosetting resin and of hardener, preferentially from 50% to 90% by weight of thermosetting resin and of hardener.

Advantageously, the composition comprises from 1% to 50% by weight of an oligomeric polyamide mixture, preferentially from 10% to 50% by weight of an oligomeric polyamide mixture.

Advantageously, the composition comprises from 50% to 90% by weight of thermosetting resin and of hardener and from 10% to 50% of oligomeric polyamide mixture.

The term “oligomeric” in the oligomeric polyamide mixture denotes a compound with a number-average molar mass Mn of between 1000 and 5000.

For the purposes of the invention, the term thermosetting resin means a resin chosen especially from cyanoacrylates, bismaleimide precursors and bearing oxirane functions such as epoxy resins.

Among the cyanoacrylates, mention may be made of 2-cyanoacrylic esters of formula CH2=C(CN)COOR with various possible groups R.

Among the bismaleimide precursors, mention may be made of benzophenone dianhydride. The thermoset formulations of bismaleimide type are, for example:

methylenedianiline+benzophenone dianhydride+nadic imide
methylenedianiline+benzophenone dianhydride+phenylacetylene
methylenedianiline+maleic anhydride+maleimide.

Advantageously, the thermosetting resin is an epoxy resin. The term “epoxy resin”, denoted hereinbelow by E, means any organic compound bearing at least two functions of oxirane type, which is polymerizable by ring opening. The term “epoxy resins” denotes all the usual epoxy resins that are liquid at room temperature (23° C.) or at higher temperature. These epoxy resins may be monomeric or polymeric, on the one hand, and aliphatic, cycloaliphatic, heterocyclic or aromatic, on the other hand. As example of such epoxy resins, mention may be made of resorcinol diglycidyl ether, bisphenol A diglycidyl ether, triglycidyl-p-aminophenol, bromobisphenol F diglycidyl ether, m-aminophenyl triglycidyl ether, tetraglycidylmethylenedianiline, (trihydroxyphenyl)methane triglycidyl ether, novolac phenol-formaldehyde polyglycidyl ethers, novolac orthocresol polyglycidyl ethers and tetraphenylethane tetraglycidyl ethers. Mixtures of at least two of these resins may also be used.

Epoxy resins bearing at least 1.5 oxirane functions per molecule and more particularly epoxy resins containing between 2 and 4 oxirane functions per molecule are preferred. Epoxy resins bearing at least one aromatic ring, such as bisphenol A diglycidyl ethers, are also preferred.

For the purposes of the invention, the term hardener generally means epoxy resin hardeners which react at room temperature or at temperatures above room temperature. Nonlimiting examples that may be mentioned include:
Acid anhydrides, including succinic anhydride,
Aromatic, cycloaliphatic or aliphatic polyamines, including diaminodiphenyl sulfone (DDS) or methylenedianiline or 4,4′-methylenebis(3-chloro-2,6-diethylaniline) (MCDEA),
Dicyandiamide and derivatives thereof.
Imidazoles
Polycarboxylic acids
Polyphenols.

A person skilled in the art can readily determine the amount of hardener relative to the amount of thermosetting resin taking into account the available functions which may be borne by the polyamide (or the copolymer). The higher the proportion of polyamide (or copolymer), the better the toughness of the material (or the resistance to cracking).

Advantageously, the resin is an epoxy resin and the optional hardener is a polyamine.

Advantageously, the polyamide contains at least 50% by weight of units consisting of diamine residues of formula (1) condensed with diacid.

For the purposes of the invention, the term polyamide (homopolyamide or copolyamide) means the condensation products of lactams, amino acids and/or diacids with diamines and, as a general rule, any polymer formed by units or monomers linked together via amide groups, and which comprise at least one monomer resulting from the condensation of a diacid and a diamine of formula (1) below:

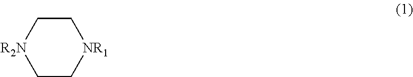

in which:
   R₁ represents H or —Z1-NH2 and Z1 represents an alkyl, a cycloalkyl or an aryl containing up to 15 carbon atoms, and
   R₂ represents H or —Z2-NH2 and Z2 represents an alkyl, a cycloalkyl or an aryl containing up to 15 carbon atoms,
   R₁ and R₂ possibly being identical or different.

In the present description of the polyamides, the term “monomer” should be taken in the sense as a “repeating unit”. The case where a repeating unit of the polyamide consists of a combination of a diacid with a diamine is particular. It is considered that it is a combination of a diamine and a diacid, i.e. the diamine.diacid couple (in equimolar amount), which corresponds to the monomer. This is explained by the fact that, individually, the diacid or the diamine is only a structural unit, which is insufficient by itself to polymerize. In the case where the polyamides according to the invention comprise at least two different monomers, known as “comonomers”, i.e. at least one monomer and at least one comonomer (monomer different from first monomer), they comprise a copolymer such as a copolyamide, abbreviated as COPA.

The term “copolyamide” (abbreviated as COPA) means the products of polymerization of at least two different monomers chosen from:
monomers of amino acid or aminocarboxylic acid type, and preferably α,ω-aminocarboxylic acids;
monomers of lactam type containing from 3 to 18 carbon atoms on the main ring and which may be substituted;
monomers of “diamine.diacid” type derived from the reaction between an aliphatic diamine containing from 4 to 36 carbon atoms and preferably from 4 to 18 carbon atoms and a dicarboxylic acid containing from 4 to 36 carbon atoms and preferably from 4 to 18 carbon atoms; and
mixtures thereof, with monomers bearing a different number of carbons in the case of mixtures between a monomer of amino acid type and a monomer of lactam type.

### Monomers of Amino Acid Type:

As examples of α,ω-amino acids, mention may be made of those containing from 4 to 18 carbon atoms, such as aminocaproic, 7-aminoheptanoic, 11-aminoundecanoic, N-heptyl-11-aminoundecanoic and 12-aminododecanoic acids.

### Monomers of Lactam Type:

As examples of lactams, mention may be made of those containing from 3 to 18 carbon atoms on the main ring and which may be substituted. Examples that may be mentioned include β,β-dimethylpropriolactam, α,α-dimethylpropriolactam, amylolactam, caprolactam also known as lactam 6, capryllactam also known as lactam 8, oenantholactam and lauryllactam also known as lactam 12.

### Monomers of “Diamine.Diacid” Type:

As examples of dicarboxylic acids, mention may be made of acids containing from 4 to 36 carbon atoms. Examples that may be mentioned include adipic acid, sebacic acid, azelaic acid, suberic acid, isophtalic acid, butanedioic acid, 1,4-cyclohexyldicarboxylic acid, terephthalic acid, the sodium or lithium salt of sulfoisophthalic acid, dimerized fatty acids (these dimerized fatty acids have a dimer content of at least 98% and are preferably hydrogenated) and dodecanedioic acid HOOC—(CH₂)₁₀—COOH, and tetradecanedioic acid.

The term “fatty acid dimers” or “dimerized fatty acids” more particularly means the product of the dimerization reaction of fatty acids (generally contains 18 carbon atoms, often a mixture of oleic acid and/or linoleic acid). It is preferably a mixture comprising from 0 to 15% of C18 monoacids, from 60% to 99% of C36 diacids and from 0.2% to 35% of C54 or more triacids or polyacids.

As examples of diamines of formula (1), mention may be made of diamines in which R1 and R2 denote H, i.e. piperazine, and those in which R1 is H and R2 is —CH2-CH2-NH2, i.e. aminoethylpiperazine. The polyamide of the composition of the invention preferably comprises at least one diamine of formula (1) chosen from piperazine (abbreviated as “Pip”), aminoethylenepiperazine, and mixtures thereof.

As examples of diamines that may be used in addition to that of formula (1), mention may be made of aliphatic diamines containing from 4 to 36 carbon atoms, preferably from 4 to 18 atoms, which may be aryl and/or saturated cyclic. Examples that may be mentioned include hexamethylenediamine, tetramethylenediamine, octamethylenediamine, decamethylenediamine, dodecamethylenediamine, 1,5-diaminohexane, 2,2,4-trimethyl-1,6-diaminohexane, diamine polyols, isophorone diamine (IPD), methylpentamethylenediamine (MPMD), bis(aminocyclohexyl)methane (BACM), bis(3-methyl-4-aminocyclohexyl) methane (BMACM), meta-xylyenediamine and bis(p-aminocyclohexyl)methane.

As other examples of monomers of “diamine.diacid” type, mention may be made of those resulting from the condensation of hexamethylenediamine with a C6 to C36 diacid, especially the monomers: 6.6, 6.10, 6.11, 6.12, 6.14, 6.18. Mention may be made of monomers resulting from the condensation of decanediamine with a C6 to C36 diacid, especially the monomers: 10.10, 10.12, 10.14, 10.18. Mention may also be made of copolyamides resulting from the condensation of at least one α,ω-aminocarboxylic acid (or a lactam), at least one diamine of formula (1) and at least one dicarboxylic acid. Mention may also be made of copolyamides resulting from the condensation of a diamine of formula (1) with an aliphatic dicarboxylic acid and at least one other monomer chosen from aliphatic diamines other than the preceding and aliphatic diacids other than the preceding. Advantageously, the PA used in the composition according to the invention is obtained at least partially from biosourced starting materials.

The term “starting materials of renewable origin” or “biosourced starting materials” means materials which comprise biosourced carbon or carbon of renewable origin. Specifically, unlike materials derived from fossil materials, materials composed of renewable starting materials contain 14C. The “content of carbon of renewable origin” or “content of biosourced carbon” is determined by applying standards ASTM D 6866 (ASTM D 6866-06) and ASTM D 7026 (ASTM D 7026-04).

As examples of amino acids of renewable origin, mention may be made of: 11-aminoundecanoic acid produced, for example, from castor oil, 12-aminododecanoic acid produced, for example, from castor oil, 10-aminodecanoic acid produced from decylenic acid obtained by metathesis of oleic acid, for example, 9-aminononanoic acid produced, for example, from oleic acid.

As examples of diacids of renewable origin, mention may be made, as a function of the number x of carbons in the molecule (Cx), of:
C4: succinic acid, for example from glucose;
C6: adipic acid, for example from glucose;
C7: heptanedioic acid from castor oil;
C9: azelaic acid, for example from oleic acid (ozonolysis);
C10: sebacic acid, for example from castor oil;
C11: undecanedioic acid from castor oil;
C12: dodecanedioic acid from biofermentation of dodecanoic acid=lauric acid (rich oil: palm kernel oil and coconut oil) for example;
C13: brassylic acid, for example from erucic acid (ozonolysis) which is found in rapeseed;
C14: tetradecanedioic acid, for example by biofermentation of myristic acid (rich oil: palm kernel oil and coconut oil);
C16: hexadecanedioic acid, for example by biofermentation of palmitic acid (mainly palm oil);
C18: octadecanedioic acid, for example obtained by biofermentation of stearic acid (a small amount in all plant oils, but mainly in animal fats);
C20: eicosanedioic acid, for example obtained by biofermentation of arachidic acid (mainly in rapeseed oil);
C22: docosanedioic acid, for example obtained by metathesis of undecylenic acid (castor oil);
C36: fatty acid dimer derived from resinous by-products formed via Kraft processes.

As examples of diamines of renewable origin, mention may be made, as a function of the number x of carbons in the molecule (Cx), of:
C4: butanediamine obtained by amination of succinic acid;
C5: pentamethylenediamine (from lysine);
   and so on for the diamines obtained by amination of the diacids of renewable origin seen previously.

Advantageously, the polyamide results from the condensation:
of least one diacid chosen from saturated aliphatic diacids containing from 2 to 36 carbon atoms, preferably from 2 to 18 carbon atoms,
of at least one diamine of formula (1),
of least one α,ω-aminocarboxylic acid or a lactam.

Preferably, the polyamide results from the condensation:
of least one diacid chosen from saturated aliphatic diacids containing from 6 to 12 carbon atoms,
of at least one diamine of formula (1),
of at least one α,ω-aminocarboxylic acid or a lactam.

By way of example, mention may be made of polyamides resulting from the condensation:
of one or two diacids chosen from saturated aliphatic diacids containing from 6 to 12 carbon atoms,
of a diamine of formula (1), advantageously piperazine,
of an α,ω-aminocarboxylic acid or a lactam, advantageously chosen from 11-aminoundecanoid acid and lauryllactam.

Advantageously, the polyamide comprises from 10 mol % to 100 mol %, preferably from 40 mol % to 100 mol %, preferably from 50 mol % to 100 mol %, preferably from 60 mol % to 100 mol %, of at least one monomer chosen from: Pip.9, Pip.10, Pip.12, Pip.14, Pip.18, Pip.36, AEP.6, AEP.9, AEP.10, AEP.12, AEP.14, AEP.18, AEP.36, and mixtures thereof, relative to the total number of moles of polyamide in the composition.

Advantageously, the polyamide also comprises at least one of the following monomers: 4.6, 4.T, 5.4, 5.9, 5.10, 5.12, 5.13, 5.14, 5.16, 5.18, 5.36, 6, 6.4, 6.9, 6.10, 6.12, 6.13, 6.14, 6.16, 6.18, 6.36, 6.T, 9, 10.4, 10.9, 10.10, 10.12, 10.13, 10.14, 10.16, 10.18, 10.36, 10.T, 11, 12, 12.4, 12.9, 12.10, 12.12, 12.13, 12.14, 12.16, 12.18, 12.36, 12.T, and mixtures thereof in the form of an alloy or a copolyamide.

Preferably, the polyamide used in the present invention comprises at least one homopolyamide chosen from PA Pip.9, PA Pip.10, PA Pip.12, PA Pip.14, PA Pip.18, PA Pip.36, PA AEP.6, PA AEP.9, PA AEP.10, PA AEP.12, PA AEP.14, PA AEP.18, PA AEP.36, and mixtures thereof and/or at least one copolyamide chosen from: PA Pip.9/Pip.12/11, PA 6/Pip.12/12, PA 6.10/Pip.10/Pip.12, PA Pip.12/12, PA Pip.10/12, PA Pip.10/11/Pip.9, and in particular those whose mass ratios are defined above, and mixtures of these copolyamides.

Use is preferably made of one or more of the following copolyamides in the composition or the thermoset material of the present invention (the mole ratios of which are indicated in parentheses)
PA Pip.9/Pip.12/11 of mass ratio 15/70/15 (16/63/21);
PA 6/Pip.12/12 of mass ratio 30/20/50 (46/10/44);
PA 6.10/Pip.10/Pip.12 of mass ratio 20/40/40 (40/31/29);
PA Pip.12/12 of mass ratio 35/65 (25/75)
PA Pip.10/12 of mass ratio 72/28 (64/36)
PA Pip.10/11/Pip.9 of mass ratio 65/30/5 (57/38/5)

As examples of copolyamides, mention may be made especially of those sold under the names Platamid® and Platamid® Rnew by ARKEMA, Vestamelt® by Evonik and Griltex® by EMS.

According to another form of the invention, the polyamide is a copolymer containing polyamide blocks and polyether blocks, the polyamide blocks resulting from the condensation of at least one diacid chosen from the preceding diacids and of at least one diamine of formula (1). That is to say that the polyamide blocks of the copolymer bearing polyamide blocks and polyether blocks are the polyamide described in the preceding paragraph.

The copolymers bearing polyamide blocks and polyether blocks result from the copolycondensation of polyamide blocks bearing reactive end groups with polyether blocks bearing reactive end groups, such as, inter alia:

1) Polyamides blocks bearing diamine chain ends with polyoxyalkylene blocks bearing dicarboxylic chain ends.

2) Polyamide blocks bearing dicarboxylic chain ends with polyoxyalkylene blocks bearing diamine chain ends obtained by cyanoethylation and hydrogenation of α,ω-dihydroxylated aliphatic polyoxyalkylene blocks known as polyetherdiols.

3) Polyamide blocks bearing dicarboxylic chain ends with polyetherdiols, the products obtained being, in this particular case, polyetheresteramides.

The polyamide blocks bearing carboxylic chain ends are obtained by using a diacid chain limiter, i.e. the condensation of the diamine of formula (1) and of the diacid is performed with an excess of this diacid or by adding another diacid. The polyamide blocks bearing diamine chain ends are obtained by using a diamine chain limiter, i.e. the condensation of the diamine of formula (1) and of the diacid is formed with an excess of this diamine or by adding another diamine. The polyamide blocks may comprise other units chosen from α,ω-aminocarboxylic acids and diamines other than the diamine of formula (1). Examples of such monomers have been described above.

Advantageously, the copolymer bearing polyamide blocks and polyether blocks contains at least 50% by weight of units consisting of residues of the diamine of formula (1) condensed with the diacid.

The polyether blocks may represent 5% to 85% by weight of the copolymer bearing polyamide and polyether blocks. The polyether blocks consist of alkylene oxide units. These units may be, for example, ethylene oxide, propylene oxide or tetrahydrofuran units (which leads to polytetramethylene glycol sequences). Use is thus made of PEG blocks, i.e. those consisting of ethylene oxide units, PPG blocks, i.e. those consisting of propylene oxide units, and PTMG blocks, i.e. those consisting of tetramethylene glycol units also known as polytetrahydrofuran. Use may be made of PEG blocks or of blocks obtained by oxyethylation of bisphenols, for instance bisphenol A. The latter products are described in patent EP 613 919.

The polyether blocks may also consist of ethoxylated primary amines. Use may also be made of these blocks. As examples of ethoxylated primary amines, mention may be made of the products of formula:

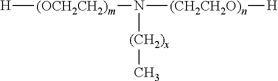

in which m and n are between 1 and 20 and x is between 8 and 18. These products are commercially available under the brand name Noramox® from the company CECA and under the brand name Genamin® from the company Clariant.

The amount of polyether blocks in these copolymers bearing polyamide blocks and polyether blocks is advantageously from 10% to 70% by weight of the copolymer and preferably from 35% to 60%.

The polyetherdiol blocks are either used as such and copolycondensed with polyamide blocks bearing carboxylic end groups, or they are aminated to be converted into diamine polyether and condensed with polyamide blocks bearing carboxylic end groups. They may also be mixed with polyamide precursors and a diacid chain limiter to make polymers bearing polyamide blocks and polyether blocks having statistically distributed units.

The number-average molar mass M̅n̅ of the polyamide blocks is between 500 and 10 000 and preferably between 500 and 4000, except for the polyamide blocks of the second type. The mass M̅n̅ of the polyether blocks is between 100 and 6 000 and preferably between 200 and 3 000.

These polymers bearing polyamide blocks and polyether blocks, whether they are derived from the copolycondensation of polyamide and polyether blocks prepared previously or from a one-step reaction have, for example, an intrinsic viscosity of between 0.8 and 2.5 measured in meta-cresol at 250° C. for an initial concentration of 0.8 g/100 ml.

As regards their preparation, the copolymers of the invention may be prepared via any means for attaching the polyamide blocks and the polyether blocks. In practice, essentially two processes are used, one being a “two-step” process and the other a “one-step” process. In the two-step process, the polyamide blocks are first manufactured and then, in a second step, the polyamide blocks and the polyether blocks are attached. In the one-step process, the polyamide precursors, the chain limiter and the polyether are mixed. A polymer essentially containing polyether blocks, polyamide blocks of very variable length, but also the various reagents which have reacted randomly, and which are distributed randomly (statistically) along the polymer chain, is then obtained. Whether it is a one-step or two-step process, it is advantageous to work in the presence of a catalyst. Use may be made of the catalysts described in patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920. In the one-step process, polyamide blocks are also manufactured. This is why it was written at the start of this paragraph that the copolymers of the invention could be prepared via any means for attaching the polyamide blocks and the polyether blocks.

The preparation processes in which the polyamide blocks bear carboxylic end groups and the polyether is a polyetherdiol are now described in detail.

The two-step process consists first in preparing the polyamide blocks bearing carboxylic end groups and then, in a second step, in adding the polyether and a catalyst. The reaction for preparing the polyamide bearing carboxylic end groups is usually performed between 180 and 300° C., preferably 200 to 260° C. The pressure in the reactor becomes established between 5 and 30 bar, and is maintained for about 2 hours. The pressure is reduced slowly while returning the reactor to atmospheric pressure and the excess water is then distilled off, for example over one or two hours.

Once the polyamide bearing carboxylic acid end groups has been prepared, the polyether and a catalyst are then added. The polyether may be added in one or more portions, as may the catalyst. According to an advantageous form, the polyether is first added, the reaction of the OH end groups of the polyether and of the COOH end groups of the polyamide begins with formations of ester bonds and removal of water; a maximum amount of water is removed from the reaction medium by distillation and the catalyst is then introduced to complete the bonding of the polyamide blocks and the polyether blocks. This second step is performed with stirring, preferably under a vacuum of at least 5 mmHg (650 Pa) at a temperature such that the reagents and the copolymers obtained are in melted form. By way of example, this temperature may be between 100 and 400° C. and usually between 200 and 300° C. The reaction is monitored by measuring the torque exerted by the molten polymer on the stirrer or by measuring the electrical power consumed by the stirrer. The end of the reaction is determined by the target torque or power value. The catalyst is defined as being any product that facilitates the bonding of the polyamide blocks and the polyether blocks by esterification. The catalyst is advantageously a derivative of a metal (M) chosen from the group formed by titanium, zirconium and hafnium.

Examples of derivatives that may be mentioned include tetraalkoxides which correspond to the general formula M(OR)₄, in which M represents titanium, zirconium or hafnium and the radicals R, which may be identical or different, denote linear or branched alkyl radicals containing from 1 to 24 carbon atoms.

The C₁ to C24 alkyl radicals from which are chosen the radicals R of the tetraalkoxides used as catalysts in the process according to the invention are, for example, those such as methyl, ethyl, propyl, isopropyl, butyl, ethylhexyl, decyl, dodecyl and hexadodecyl. The preferred catalysts are tetraalkoxides for which the radicals R, which may be identical or different, are C₁ to C₈ alkyl radicals. Examples of such catalysts are especially Zᵣ(OC₂H₅)₄, Zᵣ(O-isoC₃H₇)₄, Zᵣ(OC₄H₉)₄, Zᵣ(OC₅H₁₁)₄, Zᵣ(OC₆H₁₃)₄, H_{f}(OC₂H₅)₄, H_{f}(OC₄H₉)₄, H_{f}(O-isoC₃H₇)₄.

The catalyst used in this process according to the invention may consist solely of one or more of the tetraalkoxides of formula M(OR)₄ defined previously. It may also be formed by a combination of one or more of these tetraalkoxides with one or more alkali metal or alkaline-earth metal alkoxides of formula (R₁O)ₚY in which R₁ denotes a hydrocarbon-based residue, advantageously a C₁ to C24 and preferably C₁ to C₈ alkyl residue, Y represents an alkali metal or alkaline-earth metal and p is the valency of Y. The amounts of alkali metal or alkaline-earth metal alkoxide and of zirconium or hafnium tetraalkoxides that are combined to make the mixed catalyst may vary within large extents. However, it is preferred to use amounts of alkoxide and of tetraalkoxides such that the mole proportion of alkoxide is substantially equal to the mole proportion of tetraalkoxide.

The weight proportion of catalyst, i.e. of the tetraalkoxide(s) when the catalyst does not contain any alkali metal or alkaline-earth metal alkoxide or of all of the tetraalkoxide(s) and of the alkali metal or alkaline-earth metal alkoxide(s) when the catalyst is formed by a combination of these two types of compound, advantageously ranges from 0.01% to 5% of the weight of the mixture of the dicarboxylic polyamide with the polyoxyalkylene glycol, and is preferably between 0.05% and 2% of this weight.

As examples of other derivatives, mention may also be made of salts of the metal (M), in particular salts of (M) and of an organic acid and complex salts between the oxide of (M) and/or the hydroxide of (M) and an organic acid. Advantageously, the organic acid may be formic acid, acetic acid, propionic acid, butyric acid, valeric acid, caproic acid, caprylic acid, lauric acid, myristic acid, palmitic acid, stearic acid, oleic acid, linoleic acid, linolenic acid, cyclohexanecarboxylic acid, phenylacetic acid, benzoic acid, salicylic acid, oxalic acid, malonic acid, succinic acid, glutaric acid, adipic acid, maleic acid, fumaric acid, phthalic acid and crotonic acid. Acetic and propionic acid are particularly preferred. Advantageously, M is zirconium. These salts may be referred to as zirconyl salts. Without wishing to be bound by this explanation, the Applicant thinks that these salts of zirconium and of an organic acid or the complex salts mentioned above release ZrO⁺⁺ during the process. The product sold under the name zirconyl acetate is used. The amount to be used is the same as for the derivatives M(OR)₄.

This process and these catalysts are described in patents U.S. Pat. No. 4,332,920, U.S. Pat. No. 4,230,838, U.S. Pat. No. 4,331,786, U.S. Pat. No. 4,252,920, JP 07145368A, JP 06287547A, and EP 613919.

As regards the one-step process, all the reagents used in the two-step process are mixed, i.e. the polyamide precursors, the polyether and the catalyst. They are the same reagents and the same catalyst as in the two-step process described above.

The copolymer has essentially the same polyether blocks and the same polyamide blocks, but also a small part of the various reagents that have reacted randomly which are randomly distributed along the polymer chain.

The reactor is closed and heated with stirring as in the first step of the two-step process described above. The pressure becomes established between 5 and 30 bar. When it no longer changes, the reactor is placed under a reduced pressure, while maintaining vigorous stirring of the molten reagents. The reaction is monitored as previously for the two-step process.

The catalyst used in the one-step process is preferably a salt of the metal (M) and of an organic acid or a complex salt between the oxide of (M) and/or the hydroxide of (M) and an organic acid.

The preparation processes in which the polyamide blocks bear carboxylic end groups and the polyether is a polyetherdiamine are now described in detail.

The two-step process consists first in preparing the polyamide blocks bearing carboxylic end groups by condensation of the polyamide precursors in the presence of a chain-limiting dicarboxylic acid and then, in a second step, in adding the polyether and optionally a catalyst.

The reaction usually takes place between 180 and 300° C., preferably from 200 to 260° C. The pressure in the reactor becomes established between 5 and 30 bar and is maintained for about 2 hours. The pressure is reduced slowly while returning the reactor to atmospheric pressure, and the excess water is then distilled off, for example over one or two hours.

Once the polyamide bearing carboxylic acid end groups has been prepared, the polyether and optionally a catalyst are then added. The polyether may be added in one or more portions, as may the catalyst. According to an advantageous form, the polyether is first added, the reaction of the NH₂ end groups of the polyether and of the COOH end groups of the polyamide begins with formation of amide bonds and removal of water. A maximum amount of water is removed from the reaction medium by distillation and the optional catalyst is then introduced to complete the bonding of the polyamide blocks and the polyether blocks. This second step is performed with stirring, preferably under a vacuum of at least 5 mmHg (650 Pa) at a temperature such that the reagents and the copolymers obtained are in molten form. By way of example, this temperature may be between 100 and 400° C. and usually between 200 and 300° C. The reaction is monitored by measuring the torque exerted by the molten polymer on the stirrer or by measuring the electrical power consumed by the stirrer. The end of the reaction is determined by the target torque or power value. The catalyst is defined as being any product for facilitating the bonding of the polyamide blocks and the polyether blocks. A person skilled in the art prefers protic catalysis.

As regards the one-step process, all the reagents used in the two-step process are mixed, i.e. the polyamide precursors, the chain-limiting dicarboxylic acid, the polyether and the catalyst. These are the same reagents and the same catalyst as in the two-step process described above.

The copolymer has essentially the same polyether blocks and the same polyamide blocks, but also a small part of the various reagents which reacted randomly, which are randomly distributed along the polymer chain.

The reactor is closed and heated with stirring as in the first step of the two-step process described above. The pressure becomes established at between 5 and 30 bar. When it no longer changes, the reactor is placed under reduced pressure while maintaining vigorous stirring of the molten reagents. The reaction is monitored as previously for the two-step process.

The weight proportions in the thermoset composition or matrix according to the invention are:
50% to 90%, preferably from 50% to 85%, preferably from 50% to 80% of thermosetting resin and of hardener,
10% to 50%, preferably from 15% to 50%, preferably from 20% to 50% of mixture of polyamide and of oligomer in respective weight proportions of from 1/5 to 5/1;
   relative to the total weight of the composition.

The composition of the invention may also comprise, per 100 parts of the combination of thermosetting resin, hardener, polyamide and oligomer, up to 60 parts of an impact modifier comprising at least one copolymer chosen from copolymers bearing S-B-M, B-M and M-B-M blocks in which:
each block is linked to the other by means of a covalent bond or an intermediate molecule linked to one of the blocks by a covalent bond and the other block by another covalent bond,
M is a PMMA homopolymer or a copolymer comprising at least 50% by weight of methyl methacrylate, in particular M corresponds to methyl methacrylate,
B is incompatible with the thermoset resin and with the block M and its glass transition temperature Tg is less than the working temperature of the thermoset material obtained by the crosslinking of the composition of the invention, in particular B is butadiene,
S is incompatible with the thermoset resin, block B and block M and its Tg or its melting point Tf is greater than the Tg of B, in particular S is styrene. These impact modifiers were described in application WO 0192415 A1.
   Advantageously, the copolymer is the copolymer bearing S-B-M blocks.

More advantageously, the copolymer bearing S-B-M blocks is styrene-butadiene-methacrylate.

The term “incompatible” means that B and S are immiscible with the thermoset resin, that M and B are mutually immiscible and that S, B and M are also mutually immiscible.

The amount added is advantageously up to 20 parts per 100 parts of composition, i.e. per 100 parts of the combination of thermosetting resin, hardener, polyamide and oligomer.

The compositions of the invention may be prepared by mixing the various constituents in any conventional mixing device while remaining under conditions such that they do not crosslink. The compositions are recovered in liquid, pasty or solid form, depending on their nature. They are then placed in molds, or spread on surfaces and then crosslinked. The thermoset material is thus obtained. The solid compositions (before crosslinking) may be ground so as to be used subsequently in powder form.

Advantageously, the crosslinking is performed by simple heating.

As regards the epoxy resins, the materials of the invention with a low percentage of polyamide (≦20% by mass) may be prepared using a conventional stirred reactor. The thermosetting epoxy resin is introduced into the reactor and brought for a few minutes to a temperature sufficient to be fluid. The polyamide or copolymer and the oligomer are then added and blended at a temperature sufficient to be fluid until fully dissolved (below 120° C.). The blending time depends on the nature of the polyamide or of the copolymer added. The hardener is then added and the whole is mixed for a further 5 minutes at a temperature sufficient to be fluid to obtain a homogeneous mixture. The epoxy-hardener reaction begins during this mixing and it should thus be set as short as possible. These mixtures are then cast and cured in a mold.

For the materials with a content of polyamide or copolymer greater than 20% by mass, a premix of the thermosetting resin and of the polyamide (or copolymer) is prepared according to the following method: the epoxide in solid form, the polyamide, the oligomer and the hardener are placed in a twin-screw extruder at a temperature allowing the mixing of these various constituents, without, however, reaching the gel point. The mixture obtained is then ground and used in powder applications (powder coating).

The curing or hardening conditions are the usual conditions.

It would not constitute a departure from the context of the invention to add to the thermoset materials (before crosslinking) the usual/core-shell additives, liquid elastomers and rubbers, high-Tg thermoplastics, additives of block copolymer type, or additives for modifying the fire or electrical properties or mineral additives of any type such as glass (in fiber or bead form), and also organic fibers of any type such as carbon or aramid fibers.

The standards used in the description of the present invention are, for each parameter, indicated in table 1 below:

TABLE 1

| | Standards of the description | |
|---|---|---|
| | Standards used | ISO corre- |
| Parameters measured | in the examples | spondence |
| (A) Viscosity (180° C. × 10 s) | JIS K7117-1 | ISO2555 |
| (B) Tg (DMA) | JIS K7244-5 | 6721-5 |
| (C) K1C | ASTM D5045 | |
| (G) G1C (G1C = K1C\hat{ }2/Flexural modulus) | | |
| (D) Flexural modulus | JIS K7171 | 178 |
| maximum stress | JIS K7171 | 178 |
| maximum strain | JIS K7171 | 178 |
| (E) Impact strength - Charpy/notched impact | JIS K7111-1 | 179-1 |
| Impact strength - Charpy/non-notched impact | JIS K7111-1 | 179-1 |
| (F) Tensile modulus | JIS K7113 | 527 |
| maximum stress | JIS K7113 | 527 |
| maximum strain | JIS K7113 | 527 |

### Examples

### Products Used

Epoxy Resin:

Bisphenol A diglycidyl ether BADGE (EEW=190) of brand jeR 828.

Hardener:

Amine hardener, diaminodiphenyl sulfone (DDS).

Polyamide:

COPA: PA Pip.10/11/Pip.9 of mass ratio 65/30/5
(Mn˜8000 g/mol, Tf˜106° C., Tg˜25° C.)

Oligomer:

CTBN 1300X8, liquid rubber
(Mn˜3500 g/mol, Tg˜−52° C.)

### Procedure for the Examples of Table 2:

Add the COPA and/or the CTBN to the BADGE at 180° C.;
Mix until the COPA is fully dissolved (about 30 to 60 minutes) in the BADGE matrix and degas under vacuum;
Add the DDS (epoxy: DDS mol ratio=1:1), stir and homogenize, then degas under vacuum;
Pour the mixture obtained in the preceding step at 150° C. into a mold to obtain plates: 4 mm thick for measuring their mechanical properties/6 mm thick for measuring the K1C;
Hardening cycle: 2 hours at 110° C., ramp up to 200° C. at 1° C./min, and 4 hours at 200° C., then cool.

### Results for the Examples of Table 2:

In this table which summarizes the tests performed:
the reference curable resin based on epoxy and DDS in a 1/1 mol ratio is noted “RD” in table 2.
Comparative examples Cp1 to Cp3: the epoxy/COPA mixture does not give any improvement in the K1C relative to the reference curable resin RD as regards Cp1 and Cp2. On the other hand, the Tg lowers due to the miscibility between epoxy and COPA for the three examples Cp1 to Cp3. When supplemented with COPA, the epoxy matrix conserves its rigidity and its impact strength is improved.
Comparative examples Cp4 and Cp5.1 and Cp5.2: the epoxy/CTBN mixture conserves a high Tg and has an improved K1C, when compared with the reference matrix RD and with the comparative examples Cp1 to Cp3. The addition of CTBN alone to the epoxy matrix lowers its modulus significantly (about −35%).
Examples according to the invention Ex1.1 and Ex1.2: the epoxy/COPA/CTBN mixture makes it possible to obtain a matrix with a moderate decrease in Tg, a markedly improved K1c, which is even more impressive for G1c. The matrix has a rigidity and an impact strength similar to those of the reference matrix.

A synergistic effect of the COPA/CTBN mixture in the epoxy matrix on the K1C is especially noted. Whereas neither COPA alone nor CTBN alone makes it possible to improve the K1C of the epoxy matrix, the combined use of COPA and CTBN makes it possible to improve the K1C and the G1C significantly (+60%).

TABLE 2

| | | | | | | | | | | Ex1.2 |
|---|---|---|---|---|---|---|---|---|---|---|
| | | | | | | | | | Ex1.1 | 85% |
| | | | | | | | | | Cp5.2 85% | RD + |
| | | Ref. | Cp1 | Cp2 | Cp3 | Cp4 | Cp5.1 | 85% | RD + | 7.5% |
| | | RD:BADGE/DDS | 90% | 85% | 80% | 92.5 | 85% | RD + | 7.5% | COPA + |
| | | (molar | RD + | RD + | RD + | RD + | RD + | 15% | COPA + | 7.5% |
| | | ratio | 10% | 15% | 20% | 7.5% | 15% | CTBN | 7.5% | CTBN |
| Parameter | Unit | 1/1) | COPA | COPA | COPA | CTBN | CTBN | (repeated) | CTBN | (repeated) |
| (A) Viscosity (180° C. × 10 s) | mPa · s | 5 | 80 | | 693 | 11 | 21 | | 106 | 107 |
| (B) Tg (DMA) | ° C. | 217 | 178 | 172 | 151 | 212 | 208 | 212 | 179 | 187 |
| (C) K1C | MPa√m | 0.67 | 0.62 | 0.67 | 0.70 | 0.73 | 0.77 | 0.82 | 1.11 | 1.11 |
| (G) G1C | J/m2 | 159 | 146 | 171 | 196 | 230 | 320 | 362 | 550 | 578 |
| (D) Flexural modulus | Gpa | 2.82 | 2.63 | 2.63 | 2.50 | 2.32 | 1.85 | 1.86 | 2.24 | 2.13 |
| maximum stress | Mpa | 131 | 133 | 137 | 125 | 76 | 61 | 72 | 103 | 99 |
| maximum strain | % | 8.1 | 8.3 | 9.6 | 8.9 | 4.3 | 4.2 | 5.7 | 7.3 | 8.4 |
| (E) Impact strength - Charpy/ | kJ/m2 | 2.3 | 4.4 | 3.1 | 6.9 | 0.9 | 1.0 | 1.2 | 2.9 | 2.3 |
| notched impact | | | | | | | | | | |
| Impact strength - Charpy/ | kJ/m2 | 20.4 | 35.2 | 87.9 | 50.0 | 9.7 | 8.1 | 11.9 | 58.9 | 39.0 |
| non-notched impact | | | | | | | | | | |
| (F) Tensile modulus | GPa | 2.78 | 2.52 | 2.44 | 2.43 | 2.38 | 1.97 | 1.79 | 2.19 | 2.29 |
| maximum stress | Mpa | 67 | 91 | 92 | 86 | 57 | 43 | 35 | 69 | 66 |
| maximum strain | % | 3.6 | 8.4 | 9.3 | 10.5 | 3.9 | 3.3 | 2.5 | 5.5 | 4.9 |
| Difference in flexural modulus vs | | 0% | −7% | −7% | −11% | −18% | −34% | −34% | −21% | −24% |
| Ref. RD | | | | | | | | | | |
| Difference in tensile modulus vs | | 0% | −9% | −12% | −13% | −14% | −29% | −36% | −21% | −18% |
| Ref. RD | | | | | | | | | | |

1. A composition comprising by weight, the total being 100%:
50% to 99% of thermosetting resin and of hardener in a mole ratio within the range from 1/5 to 5/1, and
1% to 50% of a mixture:
of polyamide which comprises at least one monomer resulting from the condensation of a diacid and a diamine of formula (1) below: 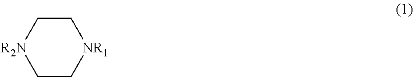
in which:
R₁ represents H or —Z1-NH2 and Z1 represents an alkyl, a cycloalkyl or an aryl containing up to 15 carbon atoms, and
R₂ represents H or —Z2-NH2 and Z2 represents an alkyl, a cycloalkyl or an aryl containing up to 15 carbon atoms,
R₁ and R₂ possibly being identical or different, and
of oligomer based on butadiene and acrylonitrile terminated either with carboxyl functions or with amine functions;
polyamide and oligomer being in respective weight proportions of from 1/10 to 10/1.

2. The composition as claimed in claim 1, in which the diamine of formula 1 is chosen from piperazine and derivatives thereof.

3. The composition as claimed in claim 1, in which the polyamide comprises from 10 mol % to 100 mol % of at least one monomer chosen from: Pip.9, Pip.10, Pip.12, Pip.14, Pip.18, Pip.36, AEP.6, AEP.9, AEP.10, AEP.12, AEP.14, AEP.18, AEP.36, and mixtures thereof, relative to the total number of moles of polyamide in the composition, Pip denoting piperazine and AEP denoting aminoethylenepiperazine.

4. The composition as claimed in claim 1, wherein the polyamide also comprises at least one of the following monomers: 4.6, 4.T, 5.4, 5.9, 5.10, 5.12, 5.13, 5.14, 5.16, 5.18, 5.36, 6, 6.4, 6.9, 6.10, 6.12, 6.13, 6.14, 6.16, 6.18, 6.36, 6.T, 9, 10.4, 10.9, 10.10, 10.12, 10.13, 10.14, 10.16, 10.18, 10.36, 10.T, 11, 12, 12.4, 12.9, 12.10, 12.12, 12.13, 12.14, 12.16, 12.18, 12.36, 12.T, and mixtures thereof in the form of an alloy or a copolyamide.

5. The composition as claimed in claim 1, wherein the polyamide comprises at least one copolyamide chosen from: PA Pip.9/Pip.12/11, PA 6/Pip.12/12, PA 6.10/Pip.10/Pip.12, PA Pip.12/12, PA Pip.10/12, PA Pip.10/11/Pip.9, and mixtures thereof.

6. The composition as claimed in claim 1, in which the polyamide is a copolymer bearing polyamide blocks and polyether blocks (PEBA), the polyamide blocks resulting from the condensation of at least one diacid and of at least one diamine of formula (1).

7. The composition as claimed in claim 1, in which the thermosetting resin is an epoxy resin.

8. The composition as claimed in claim 1, in which the hardener is a polyamine.

9. The composition as claimed in claim 1, in which the weight proportions are:
50% to 90% of curable resin and of hardener,
10% to 50% of a mixture of polyamide and oligomer in respective weight proportions of from 1/5 to 5/1;
relative to the total weight of the composition.

10. The composition as claimed in claim 1, also comprising, per 100 parts of the combination of curable resin, hardener, polyamide and oligomer, up to 60 parts of an impact modifier comprising at least one copolymer chosen from copolymers bearing S-B-M, B-M and M-B-M blocks in which:
each block is linked to the other by means of a covalent bond or of an intermediate molecule linked to one of the blocks by a covalent bond and to the other block by another covalent bond,
M is a PMMA homopolymer or a copolymer comprising at least 50% by weight of methyl methacrylate,
B is incompatible with the thermoset resin and with the block M and its glass transition temperature Tg is less than the working temperature of the thermoset material,
S is incompatible with the thermoset resin, block B and block M and its Tg or its melting point Tf is greater than the Tg of B.

11. The composition as claimed in claim 10, in which the copolymer is a copolymer bearing S-B-M blocks.

12. The composition as claimed in claim 10, in which the copolymer bearing S-B-M blocks is styrene-butadiene-methacrylate.

13. A thermoset material obtained by crosslinking the composition of claim 1.

14. The use of a mixture of polyamide and of oligomer in a thermoset matrix for improving its fracture toughness, as determined according to standard ASTMD5045,
the thermoset matrix comprising a thermosetting resin and a hardener in a mole ratio included in the range from 1/5 to 5/1,
said polyamide comprising at least one monomer resulting from the condensation of a diacid and a diamine of formula (1) below: 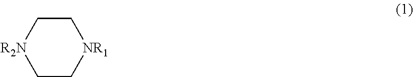
in which:
R₁ represents H or —Z1-NH2 and Z1 represents an alkyl, a cycloalkyl or an aryl containing up to 15 carbon atoms, and
R₂ represents H or —Z2-NH2 and Z2 represents an alkyl, a cycloalkyl or an aryl containing up to 15 carbon atoms,
R₁ and R₂ possibly being identical or different, and
the oligomer being based on butadiene and acrylonitrile terminated either with carboxyl functions or with amine functions; and
said mixture representing from 1% to 90% by weight, relative to the total weight of the thermoset matrix, and the polyamide and the oligomer being in respective weight proportions of from 1/10 to 10/1.
